(19) United States
(12) Patent Application Publication
(10) Pub. No.: US 2021/0405863 A1
(43) Pub. Date: Dec. 30, 2021

(54) Measurement device and method for operating a measurement device

(71) Applicant: Rohde & Schwarz GmbH & Co. KG, Munich (DE)

(72) Inventor: Jiayi CHEN, Singapore (SG)

(21) Appl. No.: 16/917,342

(22) Filed: Jun. 30, 2020

(51) Int. Cl. G06F 3/0488; G06F 3/0484

(52) U.S. Cl. CPC G06F 3/04883; G06F 3/04845; G06F 2203/04808; G06F 2203/04104; G06F 3/04842

(57) ABSTRACT

The invention relates to a measurement device, comprising: a touchscreen; wherein the touchscreen is configured to display a graphical representation of a measurement signal in a display area of the touchscreen; wherein the touchscreen is configured to detect a first and a second touch input; wherein the touchscreen is configured to display a line element in the display area upon detecting the first touch input; and wherein the touchscreen is configured to change the position of the displayed line element in the display area based on the second touch input.

### TECHNICAL FIELD OF THE INVENTION

The invention relates to the technical field of displaying measurement signals. In particular, the invention relates to a measurement device, a method for operating a measurement device and to a computer program.

### BACKGROUND OF THE INVENTION

Many test and measurement devices, such as oscilloscopes or spectrum analyzers, have an integrated screen, which displays a recorded measurement signal, for example in form of a line or point graph. Often auxiliary lines, such as horizontal limit lines or grid lines, can be superimposed on the displayed measurement signal. Such lines can be used to improve the readability of the measurement signal or to compare the signal against certain thresholds.

In most devices, a user has to use a combination of softkeys and buttons of the measurement device to add, remove or edit such auxiliary lines. However, controlling an auxiliary line in this way is cumbersome and unintuitive for the user. The user has to learn the function of different buttons, e.g. one button is used to move the line and another button controls the resolution of the movement. In addition, these additional buttons increase the cost and complexity of the measurement device.

Alternatively, the auxiliary line can be defined externally, for example as a more complex multipoint line, and loaded to the measurement device as a data file. However, this approach requires an external device on which the line is defined and an additional step of transferring the line to the measurement device, which is time consuming.

The document US 2003/0085925 A1 discloses a method of creation/editing masks/waveforms for an instrument. Thereby, a mask editor can be invoked from an application running on the instrument by touching a touch screen. The mask editor can be operated via a plurality of buttons across the screen. However, no intuitive way to display an auxiliary line in the screen is shown.

Thus, it is an objective to provide an improved measurement device and an improved method for operating a measurement device, which avoid the above-mentioned disadvantages.

### SUMMARY OF THE INVENTION

The object of the present invention is achieved by the solution provided in the enclosed independent claims. Advantageous implementations of the present invention are further defined in the dependent claims.

According to a first aspect, the invention relates to a measurement device, comprising: a touchscreen; wherein the touchscreen is configured to display a graphical representation of a measurement signal in a display area of the touchscreen; wherein the touchscreen is configured to detect a first and a second touch input; wherein the touchscreen is configured to display a line element in the display area upon detecting the first touch input; and wherein the touchscreen is configured to change the position of the displayed line element in the display area based on the second touch input. This achieves the advantage that the line element can be added and moved in the display area in a precise and intuitive way. In particular, no external buttons or softkeys are required to control the line element.

The touchscreen can be embedded in a housing or a frame member of the measurement device. A user can make an input via a finger or a stylus on the touchscreen. In particular, the touchscreen comprises or forms a touch-sensitive display element, which can detect the touch input on its surface. Detecting the touch input on the touchscreen may refer to detecting said input on the touch-sensitive display element of the touchscreen.

The touchscreen can further comprise a processing unit, which can be configured to interpret an input pattern on the touchscreen, in particular on the touch-sensitive display element, as the first or second (or other) touch input.

The display area can be a segment of the touchscreen in which the graphical representation of the measurement signal is displayed. The touchscreen can comprise further segments in which other information can be displayed, e.g. settings of the measurement device. Alternatively, the display area fills the complete displayable area of the touchscreen.

The line element can be a linear line defined by two points of the line (two point line). For instance, the linear line can be a horizontal or a vertical line. However, the line element can be a multipoint line, which can have a more complex shape defined by multiple points of the line.

For example, the measurement signal can be an electronic signal, e.g. a voltage or a current, an optical signal or an acoustic signal. In particular, the measurement signal is a radio frequency signal.

Preferably, the measurement device comprises a processing unit, which is configured to process the measurement signal and to generate the graphical representation based on the processed measurement signal.

In an embodiment, the first touch input is a swiping gesture on the display area. This achieve the advantage that the user input can be made efficiently and intuitively.

In an embodiment, the second touch input comprises a pressing and dragging gesture starting at a position of the displayed line element on the display area, wherein the touchscreen is configured to change the position of the displayed line element based on an endpoint of the pressing and dragging gesture in the display area. This achieve the advantage that the position of the line element relative to the displayed measurement signal can be adjusted precisely and intuitively.

In an embodiment, the touchscreen is configured to display grid lines in the display area, wherein the touchscreen is configured to shift the line element onto the closest grid line after changing the position of the line element. This achieve the advantage that the line element can be easily moved to a designated position.

In an embodiment, the touchscreen is configured to detect a third touch input, wherein the touchscreen is configured to remove the line element after detecting the third touch input. This achieves the advantage that the line element can be removed in a simple and intuitive way.

In an embodiment, the third touch input comprises a pressing and dragging gesture starting at a position of the displayed line element on the display area and ending outside of the display area. This achieve the advantage that the user input can be made efficiently and intuitively.

In an embodiment, the measurement device of claim 1, wherein the touchscreen is configured to detect a fourth touch input, wherein the touchscreen is configured to change a shape of the displayed line element based on the fourth touch input. This achieves the advantage that the shape of the line element can be changed in a simple and intuitive way

In an embodiment, the fourth touch input comprises a double-tab and dragging gesture, wherein the touchscreen is configured to change the shape of the displayed line element based on an endpoint of the double-tab and dragging gesture in the display area. This achieve the advantage that the user input can be made efficiently and intuitively.

In an embodiment, the line element is a multipoint line, wherein each point of the multipoint line comprises coordinates defining a position of the point in the display area, wherein the touchscreen is configured to detect a fifth touch input, and wherein the touchscreen is configured to selected a point of the multipoint line and to change the coordinates of the selected point based on the fifth touch input. This achieves the advantage that points of the line element can be edited in a simple and intuitive way. In particular, no softkeys or buttons on the measurement device are required for this editing.

In an embodiment, the graphical representation is a two-dimensional plot, in particular a line chart or a point chart, of the measurement signal.

Preferably, the display area displays axes for the two-dimensional plot, which are labeled in the units of the measurement signal. The graphical representation of the measurement signal can be displayed in an area that is delimited by the axes.

In an embodiment, the line element is a limit, a threshold and/or a marker line for the displayed measurement signal. For example, the line element can help to determine a signal level of the measurement signal without testing if the measurement signal is within any limits.

In an embodiment, the measurement device comprises at least one measurement port, which is configured to receive the measurement signal from an external device, in particular a device-under-test.

In an embodiment, the measurement device is any one of the following devices: an audio analyzer, an oscilloscope, a network analyzer, a power meter and/or volt meter, a receiver, a meter and/or counter, a signal and/or spectrum analyzer, a test and/or measurement device for broadcasting, a signal generator, a spectrum monitoring device, a wireless communications tester.

According to a second aspect, the invention relates to a method for operating a measurement device, comprising:
displaying a graphical representation of a measurement signal in a display area of a touchscreen of the measurement device;
detecting a first and a second touch input on the touchscreen;
displaying a line element in the display area upon detecting the first touch input; and
changing the position of the displayed line element in the display area based on the second touch input.

This achieves the advantage that the line element can be added and moved in the display area in a precise and intuitive way. In particular, no external buttons or softkeys are required to control the line element.

In an embodiment, the first touch input is a swiping gesture on the display area. This achieve the advantage that the user input can be made efficiently and intuitively.

In an embodiment, the second touch input comprises a pressing and dragging gesture starting at a position of the displayed line element on the display area, wherein the touchscreen is configured to change the position of the displayed line element based on an endpoint of the pressing and dragging gesture in the display area. This achieve the advantage that the position of the line element relative to the displayed measurement signal can be adjusted precisely and intuitively.

In an embodiment, the method further comprises:
detecting a third touch input; and
removing the line element after detecting the third touch input.

This achieves the advantage that the line element can be removed in a simple and intuitive way.

Preferably, the third touch input comprises a pressing and dragging gesture starting at a position of the displayed line element on the display area and ending outside of the display area.

In an embodiment, the method further comprises:
detecting a fourth touch input; and
changing a shape of the displayed line element based on the fourth touch input.

This achieves the advantage that the shape of the line element can be changed in a simple and intuitive way.

Preferably, the fourth touch input comprises a double-tab and dragging gesture, wherein the touchscreen is configured to change the shape of the displayed line element based on an endpoint of the double-tab and dragging gesture in the display area.

In an embodiment, the line element is a multipoint line, wherein each point of the multipoint line comprises coordinates defining a position of the point in the display area, wherein the method further comprises:
detecting a fifth touch input, and
selecting a point of the multipoint line and changing the coordinates of the selected point based on the fifth touch input.

This achieves the advantage that points of the line element can be edited in a simple and intuitive way. In particular, no softkeys or buttons on the measurement device are required for this editing.

Preferably, the method further comprises:
receiving the measurement signal from an external device, preferably via a measurement port of the measurement device.

The above description with regard to the measurement device according to the first aspect of the invention is correspondingly valid for the method for operating the measurement device according to the second aspect of the invention.

According to a third aspect, the invention relates to a computer program comprising a program code for performing the method according to the second aspect of the invention when executed on a computer.

### BRIEF DESCRIPTION OF THE DRAWINGS

The invention will be explained in the followings together with the figures.

FIG. 1 shows a schematic diagram of a measurement device according to an embodiment;

FIG. 2a-b shows schematic diagrams of a display area of a touchscreen according to further embodiments;

FIG. 3a-b shows schematic diagrams of a display area of a touchscreen according to further embodiments; and

FIG. 4 shows a method for operating a measurement device according to an embodiment.

### DETAILED DESCRIPTION OF THE PREFERRED EMBODIMENTS

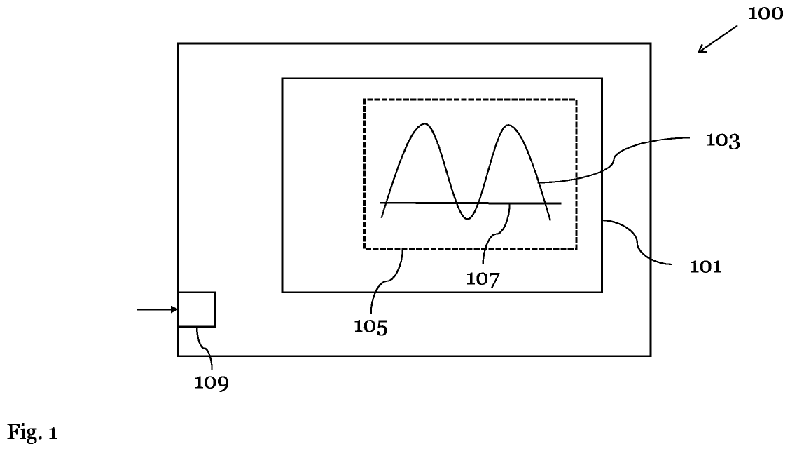

FIG. 1 shows a schematic diagram of a measurement device 100 according to an embodiment.

The measurement device 100 comprises a touchscreen 101, wherein the touchscreen 101 is configured to display a graphical representation 103 of a measurement signal in a display area 105 of the touchscreen 101, wherein the touchscreen 101 is configured to detect a first and a second touch input. The touchscreen 101 can be configured to display a line element 107 in the display area 105 upon detecting the first touch input. Further, the touchscreen 101 can be configured to change the position of the displayed line element 107 in the display area 105 based on the second touch input.

The touchscreen 101 can be a touch sensitive display that is arranged on the measurement device 100. For example, the touchscreen 101 is embedded in a housing or a frame member of the measurement device 100.

In FIG. 1, the display area 105 is confined to a segment of the full touchscreen 101 area. The touchscreen 101 can be configured to display other information, e.g. settings of the measurement device 100, outside of the display area 105.

The graphical representation 103 can be a two-dimensional plot of measurement points. The measurement points can be connected by a line or overplayed by a fitted curve. In particular, the graphical representation 103 comprises a line chart or a point chart. The touchscreen 101 can further be configured to display x- and y-axes for the two-dimensional plot, which are labeled in the units of the measurement signal.

The measurement signal can be an electronic signal, e.g. a voltage or a current, an optical signal or an acoustic signal. In particular, the electronic signal is a radio frequency signal.

The measurement device 100 can comprise at least one measurement port 109, which is configured to receive the measurement signal from an external device. The external device can be a device-under-test. The measurement port 109 can be a wireless port, e.g. a Bluetooth port, or a wire-bound port, e.g. an Ethernet or a USB port.

The measurement device 100 can further comprise a processing unit, e.g. a microprocessor. The processing unit can be configured to process the measurement signal and to generate the graphical representation 103 based on the processed measurement signal.

For example, the measurement device 100 is any one of the following devices: an audio analyzer, an oscilloscope, a network analyzer, a power meter and/or volt meter, a receiver, a meter and/or counter, a signal and/or spectrum analyzer, a test and/or measurement device for broadcasting, a signal generator, a spectrum monitoring device, or a wireless communications tester.

In a preferred embodiment, the measurement device 100 is a spectrum analyzer and the measurement signal can comprise various data points representing a signal strength at different frequencies of a frequency range, e.g. an RF signal. The graphical representation 103 of the measurement signal can be a two-dimensional graph that plots the signal strength against the frequency range.

The line element 107 can be a horizontal line, a vertical line or a more complex multipoint line. The line element 107 can form a limit line, a threshold line, a marker line and/or an auxiliary line for the displayed measurement signal. Preferably, the line element 107 is superimposed on the graphical representation 103 of the measurement signal.

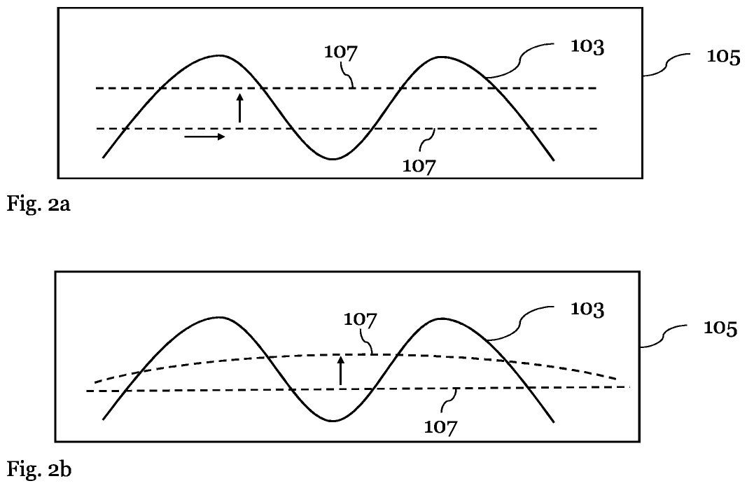

FIG. 2a-b shows schematic diagrams of the display area 105 of the touchscreen 101 according to further embodiments. In each of FIGS. 2a and 2b, the graphical representation 103 of the measurement signal is a curve.

FIG. 2a shows that the line element 107 can be displayed if a user performs the first touch input, and subsequently the position of the displayed line element 107 can be changed if the user performs the second touch input on the display area 105. Thereby, the first touch input can be, as indicated by a horizontal arrow in FIG. 2a, a linear swiping gesture on the touchscreen 101.

The line element 107 can be a horizontal line if the swiping gesture is performed in a horizontal direction, e.g. from left to right or from right to left. Preferably, the position of the horizontal line is defined by the position of the swiping gesture on the display area 105 of the touchscreen 101.

Optionally, the touchscreen 101 can be configured to display the line element in the form of a vertical line if the user performs the first touch input as a vertical swiping gesture on the display area 105.

Subsequently, the position of the line element 107 is changed if the user performs the second touch input on the display area 105. The second touch input can be a pressing and dragging gesture starting at or close to a position of the displayed line element 107 on the display area. If the line element 107 is a horizontal line, the dragging gesture can be performed in a vertical direction, as indicated by the vertical arrow in FIG. 2a. The position of the line element 107 can thereby be changed based on an endpoint of the pressing and dragging gesture in the display area 105. In other words, the user can drag the line element 107 to a position in the display area 105 with the second touch input. In this way, the position of the line element can be fine-tuned.

The touchscreen 101 can be configured to detect a third touch input, and to remove, i.e. delete, the line element 107 after detecting the third touch input. For example, the third touch input can comprises a further pressing and dragging gesture starting at the position of the displayed line element, but ending on an area of the touchscreen that lies outside of the display area 105. In other words, the user can delete the line element 107 by dragging the line element 107 out of the display area 105.

FIG. 2b shows that the shape line element 107 can be changed if the user performs a fourth touch input. The touchscreen can be configured to change a shape or form of the displayed line element 107 based on the execution of the fourth touch input.

For example, the fourth touch input comprises a double-tab at a position of the line element 107, wherein the second tab of the double-tab is a pressing on the touchscreen, which is maintained during the dragging. The dragging gesture can be performed in a vertical direction, as indicated by the vertical arrow in FIG. 2b.

The touchscreen 101 can be configured to change the shape of the displayed line element 107 based on an endpoint of the dragging gesture in the display area 105. For example, the shape of the line element 107 is changed by shifting the section of the line element 107 on which the double tab was performed to the location of the endpoint of the dragging gesture, while the of the endpoints of the line element 107 remain fixated.

Preferably, the line element 107 can be changed from a straight line to a curved, bent or angular line via the fourth touch input.

The user can use one or two fingers, or a stylus to perform the swiping, pressing, tapping and dragging gestures on the touchscreen 101. In particular, it is more intuitive and efficient to control the line element 107 through touchscreen gestures that most users are already familiarized with, than to use an unintuitive control scheme with buttons or softkeys that the users have to learn first.

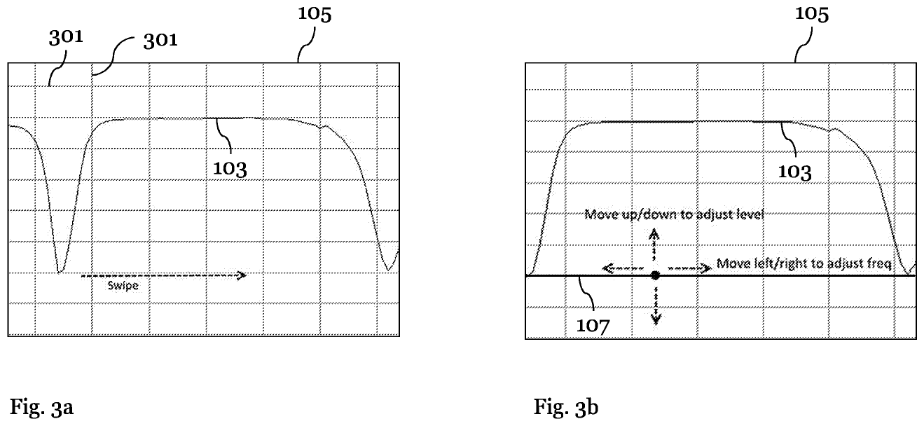

FIG. 3a-b shows schematic diagrams of the display area 105 of the touchscreen 101 according to further embodiments.

In the display areas 105 shown in FIGS. 3a and 3b, horizontal and vertical grid lines 301 are displayed. These grid lines 301 can improve a readability of the measurement signal. Preferably, the horizontal line element 107 can snap onto the closest horizontal grid line after changing the position of the line element, e.g. after performing the second touch input.

FIG. 3a further indicates the horizontal swiping gesture that can be used to initiate the display of the line element 107 at the location of the swipe.

FIG. 3b shows a fifth user input on the display area 105. Preferably, the line element 107 is a multipoint line comprising multiple points, wherein the position of the points in the display area 105 defines the shape and position of the multipoint line. Thereby, the position of each point of the line element 107 can be expressed by a set of coordinates, e.g. x-y-coordinates. The coordinates of each point can be expressed as physical parameters associated with the respective position of the point in a two-dimensional plot that is displayed in the display area 105.

For example, the two dimensional plot can plot a frequency of the measurement signal in x-direction against a signal strength in y-direction. Each point of the multipoint line can, therefore, be associated with a frequency value, defining the position on the x-axis of the two-dimensional plot, and with a signal strength, defining a position of the point in the y-axis of the two-dimensional.

Based on the fifth touch input, a point of the multipoint line can be selected or a new point can be added, and the coordinates of said selected or added point can be changed, i.e. edited. By adding a new point to a horizontal line, the line can be converted into a multipoint line.

The fifth touch input can comprise:
a double-tap on a location of the line element 107 to activate the editing of a point at said location;
a pressing and holding at the position of the activated point;
a dragging up and down on the touchscreen 101 to adjust a vertical coordinate, e.g. a signal strength; and
a dragging left and right on the touchscreen 101 to adjust a horizontal coordinate, e.g. a frequency value; and
a double-tapping again on the touchscreen 101 to exit the editing.

The up and down, as well as the left and right dragging gesture on the touchscreen 101 are indicated by the horizontal and vertical arrows in FIG. 3b.

Preferably, the first, the second the third, the fourth and the fifth touch input each comprise different gestures or a different set of gestures on the touchscreen 101, such that the inputs can easily distinguished by the user.

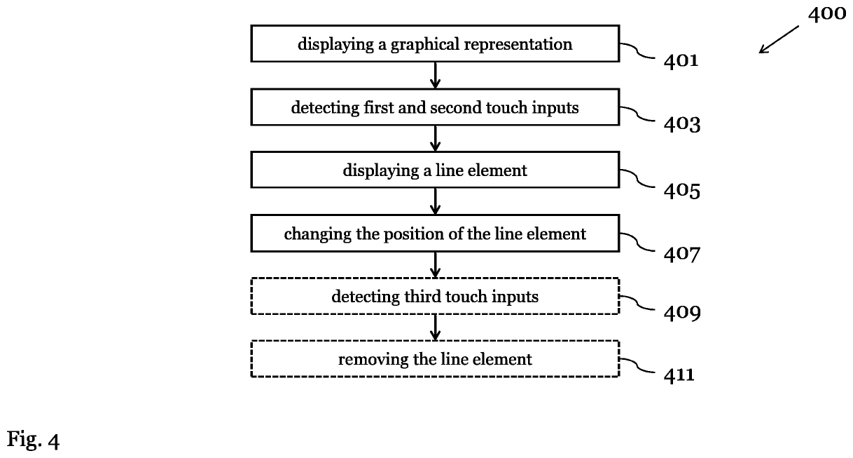

FIG. 4 shows a method 400 for operating the measurement device 100 according to an embodiment. In particular, the method 400 is a measurement device input method.

The method 400 comprises:
displaying 401 the graphical representation 103 of the measurement signal in the display area 105 of the touchscreen 101 of the measurement device 100;
detecting 403 a first and a second touch input on the touchscreen 101;
displaying 405 the line element 107 in the display area 105 upon detecting 403 the first touch input; and
changing 407 the position of the displayed line element 107 in the display area 105 based on the second touch input.

Preferably, the method 400 further comprises the steps:
detecting 409 the third touch input; and
removing 411 the line element after detecting the third touch input.

Optionally, the method 400 further comprises:
detecting the fourth touch input; and
changing a shape of the displayed line element based on the fourth touch input; and/or
detecting the fifth touch input, and
selecting a point of the multipoint line and changing the coordinates of the selected point based on the fifth touch input.

The method 400 provides a simple and intuitive way to add, edit or remove line elements 107 on the touchscreen 101 using gestures. In this way, both horizontal lines and more complex multi-point lines can both be displayed and edited. These line elements 107 can be used to perform limit tests on the measurement signal or to check signal levels against a threshold value.

All features of all embodiments described, shown and/or claimed herein can be combined with each other.

1. A measurement device, comprising:
at least one measurement port, which is configured to receive a measurement signal from an external device-under-test; and
a touchscreen;
wherein the touchscreen is configured to display a graphical representation of the measurement signal in a display area of the touchscreen;
wherein the touchscreen is configured to detect a first and a second touch input;
wherein the touchscreen is configured to display a line element in the display area upon detecting the first touch input;
wherein the touchscreen is configured to change the position of the displayed line element in the display area based on the second touch input;
wherein the second touch input comprises a pressing and dragging gesture starting at a position of the displayed line element on the display area, wherein the touchscreen is configured to change the position of the displayed line element based on an endpoint of the pressing and dragging gesture in the display area; and
wherein the touchscreen is configured to display grid lines in the display area, wherein the touchscreen is configured to shift the line element onto the closest grid line after changing the position of the line element, thereby snapping the line element onto the grid line which is closest to the endpoint of the pressing and dragging gesture.

2. The measurement device of claim 1, wherein the first touch input is a swiping gesture on the display area.

3. (canceled)

4. (canceled)

5. The measurement device of claim 1, wherein the touchscreen is configured to detect a third touch input, wherein the touchscreen is configured to remove the line element after detecting the third touch input.

6. The measurement device of claim 5, wherein the third touch input comprises a pressing and dragging gesture starting at a position of the displayed line element on the display area and ending outside of the display area.

7. The measurement device of claim 1, wherein the touchscreen is configured to detect a fourth touch input, wherein the touchscreen is configured to change a shape of the displayed line element based on the fourth touch input.

8. The measurement device of claim 7, wherein the fourth touch input comprises a double-tap and dragging gesture, wherein the touchscreen is configured to change the shape of the displayed line element based on an endpoint of the double-tab and dragging gesture in the display area.

9. The measurement device of claim 1, wherein the line element is a multipoint line, wherein each point of the multipoint line comprises coordinates defining a position of the point in the display area, wherein the touchscreen is configured to detect a fifth touch input, and wherein the touchscreen is configured to selected select a point of the multipoint line and to change the coordinates of the selected point based on the fifth touch input.

10. The measurement device of claim 1, wherein the graphical representation is a two-dimensional plot, in particular a line chart or a point chart, of the measurement signal.

11. The measurement device of claim 1, wherein the line element is a limit, a threshold and/or a marker line for the displayed measurement signal.

12. (canceled)

13. The measurement device of claim 1, wherein the measurement device is any one of the following devices: an audio analyzer, an oscilloscope, a network analyzer, a power meter and/or volt meter, a receiver, a meter and/or counter, a signal and/or spectrum analyzer, a test and/or measurement device for broadcasting, a signal generator, a spectrum monitoring device, a wireless communications tester.

14. Method for operating a measurement device, comprising:
receiving a measurement signal from an external device-under-test on at least one measurement port of the measurement device;
displaying a graphical representation of the measurement signal in a display area of a touchscreen of the measurement device;
detecting a first and a second touch input on the touchscreen;
displaying a line element in the display area upon detecting the first touch input; and
changing the position of the displayed line element in the display area based on the second touch input,
wherein the second touch input comprises a pressing and dragging gesture starting at a position of the displayed line element on the display area, wherein the touchscreen is configured to change the position of the displayed line element based on an endpoint of the pressing and dragging gesture in the display area; and
wherein the touchscreen is configured to display grid lines in the display area, wherein the touchscreen is configured to shift the line element onto the closest grid line after changing the position of the line element, thereby snapping the line element onto the grid line which is closest to the endpoint of the pressing and dragging gesture.

15. The method of claim 14, wherein the first touch input is a swiping gesture on the display area.

16. (canceled)

17. The method of claim 14, further comprising:
detecting a third touch input; and
removing the line element after detecting the third touch input.

18. The method of claim 14, further comprising:
detecting a fourth touch input; and
changing a shape of the displayed line element based on the fourth touch input.

19. The method of claim 14, wherein the line element is a multipoint line, wherein each point of the multipoint line comprises coordinates defining a position of the point in the display area, wherein the method further comprises:
detecting a fifth touch input, and
selecting a point of the multipoint line and changing the coordinates of the selected point based on the fifth touch input.

20. A computer program comprising a program code for performing the method of claim 14 when executed on a computer.
